(19) United States
(12) Patent Application Publication
(10) Pub. No.: US 2016/0309009 A1
(43) Pub. Date: Oct. 20, 2016

(54) MOBILE DEVICE CASE WITH LIGHTING AND STAND ELEMENTS

(71) Applicant: Nikki HASKELL, Los Angeles, CA (US)

(72) Inventor: Nikki HASKELL, Los Angeles, CA (US)

(21) Appl. No.: 15/099,197

(22) Filed: Apr. 14, 2016

Related U.S. Application Data
(60) Provisional application No. 62/149,244, filed on Apr. 17, 2015.

(51) Int. Cl. H04M 1/04; H04N 5/225; H04N 5/235; H04M 1/02

(52) U.S. Cl. CPC H04M 1/04; H04M 1/0264; H04M 1/0283; H04N 5/2252; H04N 5/2353; H04N 5/2256

(57) ABSTRACT

A mobile device case includes a first piece and a releasably engageable second piece. The first and second pieces are dimensioned to receive a mobile device therebetween. The first piece has a front surface and a plurality of openings. At least a portion of the front surface is reflective. A plurality of light sources are disposed within the plurality of openings. A plurality of adjustable stand elements are attached to at least one of the first and second pieces for portrait and landscape positioning of the case.

### CROSS REFERENCE TO RELATED APPLICATIONS

This application claims priority to U.S. Provisional Patent Application No. 62/149,244, filed on Apr. 17, 2015, entitled “Mobile Device Case with Lighting and Adjustable Stand Elements,” the entire contents of which are incorporated by reference herein.

### BACKGROUND OF THE INVENTION

The field of the invention relates to cases for mobile devices, and particularly cases including lighting features and adjustable stands.

There are millions—if not billions—of mobile devices used in the world today. Mobile devices, also referred to as handhelds or handheld devices, are computer-enabled electronic devices, which are generally small enough to be carried around by hand or in a pocket or purse. Commonly used mobile devices include, but are not limited to phones, tablets, Personal Digital Assistants (PDAs), cameras, gaming devices, personal navigation devices, audio players, and multimedia players. The use of mobile devices not only varies, but continues to grow day by day. But most, if not, all mobile devices in use today include a camera that allows an owner to take a “selfie.” With the explosion of social media, owners will typically take selfies and share them with their followers via platforms such as Twitter, Instagram, and FaceBook.

Owners of mobile devices carry them wherever they go—at work, play and home—and often prefer to use a case to protect and improve the aesthetic value their device. Unfortunately, most cases for mobile devices do not include a stand that allows upright positioning of the device to take selfies. Most cases also do not include additional features that would enhance the background and overall appearance of the selfie. As such, there are clear needs for improved cases for mobile devices. The present invention fulfills these needs and provides further related advantages, as described herein.

### BRIEF SUMMARY OF THE INVENTION

Briefly stated, one aspect of the present invention is directed to a mobile device case comprising a first piece having a front surface and a plurality of openings. At least a portion of the front surface is reflective. A plurality of light sources are disposed within the plurality of openings. A second piece is releasably engageable with the first piece, and the first and second pieces are dimensioned to receive a mobile device therebetween. A plurality of adjustable stand elements are attached to at least one of the first and second pieces for portrait and landscape positioning of the case.

### BRIEF DESCRIPTION OF THE SEVERAL VIEWS OF THE DRAWINGS

The following detailed description of the invention will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

In the drawings:

FIG. 1A is a front perspective view of a mobile device case in accordance with a first embodiment of the present invention with the mobile device case being positioned in a portrait orientation;

FIG. 1B is a front perspective view of the mobile device case shown in FIG. 1 with the mobile device and mobile device case being positioned in a landscape orientation;

FIG. 2 is a front exploded perspective view of a mobile device and the mobile device case shown in FIG. 1;

FIG. 3A is a front elevational view of the mobile device case shown in FIG. 1;

FIG. 3B is a front elevational view of a mobile device case in accordance with an alternative front case piece for use with the first embodiment of the present invention;

FIG. 4A is a rear elevational view of a mobile device assembled with the mobile device case shown in FIGS. 1 and 2, the case shown with adjustable stand elements being stowed within the mobile device case;

FIG. 4B is a rear elevational view of the mobile device and mobile device case shown in FIG. 4A with a first stand element being rotated to a second position and a telescoping segment of the first stand element being extended;

FIG. 4C is a rear elevational view of the mobile device and the mobile device case shown in FIG. 4A with a first stand element being rotated to a second position and two telescoping segments of the first stand element being extended;

FIG. 5A is a rear elevational view of a mobile device and the mobile device case shown in FIGS. 1 and 2 with the adjustable stand elements being stowed within the mobile device case; and

FIG. 5B is a rear elevational view of the mobile device and mobile device case shown in FIG. 5A with the first stand element being in a stowed position, the second stand element being extended, and a third stand element being extended;

FIG. 6 a front perspective view of a mobile device contained within a mobile device case in accordance with the first embodiment of the present invention with the mobile device and mobile device case being positioned in a portrait orientation; and

FIG. 7 is a front exploded perspective view of a mobile device and a mobile device case in accordance with a second embodiment of the present invention.

### DETAILED DESCRIPTION OF THE INVENTION

Certain terminology is used in the following description for convenience only and is not limiting. The words “lower” and “upper” designate directions in the drawings to which reference is made. Unless specifically set forth herein, the terms “a”, “an” and “the” are not limited to one element but instead should be read as meaning “at least one.” The terminology includes the words noted above, derivatives thereof and words of similar import.

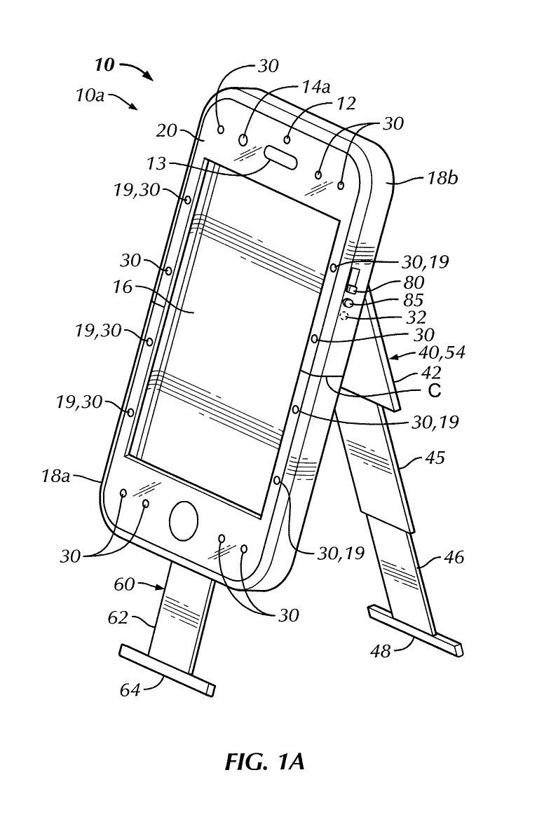

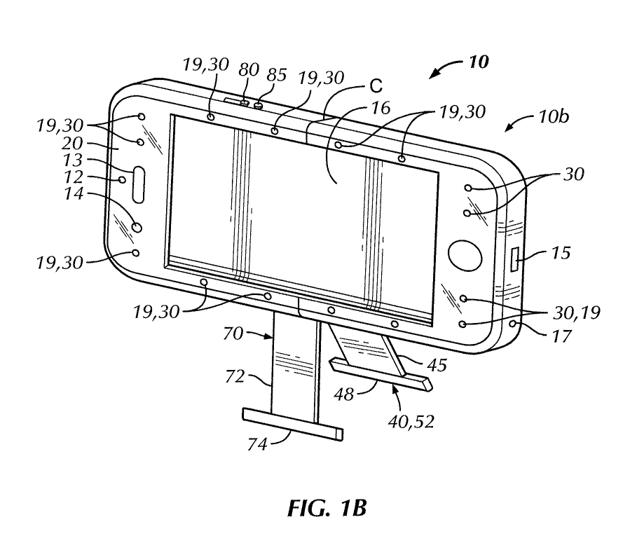

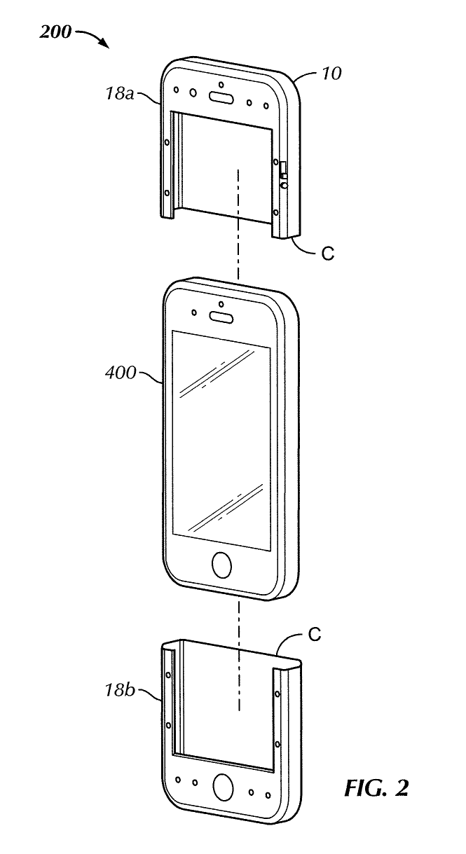

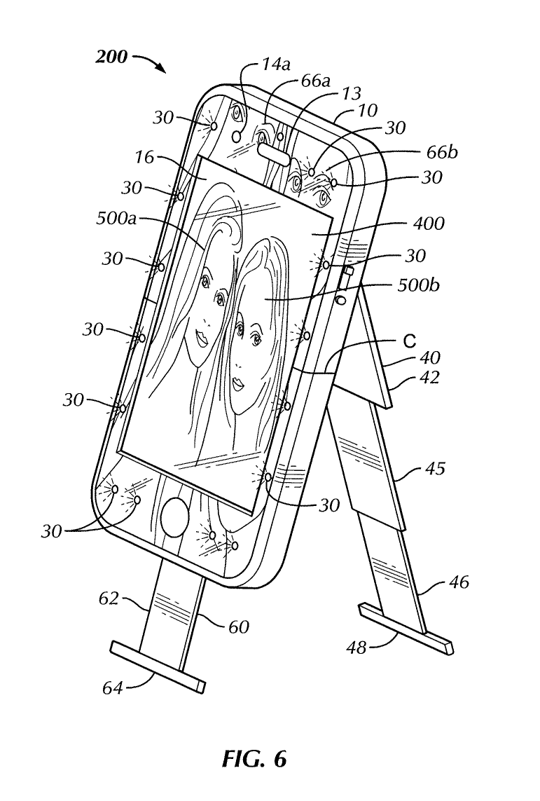

Referring to FIGS. 1A and 1B, in a first embodiment, the present invention provides a mobile device case 10 for protection of a mobile device 400 (FIGS. 2 and 6). Preferably the mobile device case 10 is formed of a high impact polymeric material or combination of materials well known in the art. The mobile device case 10 also includes additional features that enhance the appearance of photographs taken with the mobile device 400. The case 10 is particularly suited with mobile devices such as phones, tablets, Personal Digital Assistants (PDAs), cameras, gaming devices, personal navigation devices, audio players, and multimedia players. Such devices include, but are not limited to, those sold and/or manufactured by Samsung, Apple, Sony, LG, and Nokia.

The mobile device case 10 shown in FIGS. 1A and 1B is particularly suited for use with Apple iPhone devices. The case 10 includes various openings that align with complementarily positioned mobile device features. For example, the case 10 includes a sensor opening 12, a speaker/microphone opening 13, a forward facing camera opening 14a, a rearward facing camera opening 14b (FIG. 2), a power cord opening 15 (FIG. 1B), a screen opening 16 having a rectangular perimeter, a headphone opening 17 (FIG. 1B), and light openings 19. The configuration and positioning of such openings shown in the Figures, however, should not be construed as limiting. The mobile device cases disclosed herein may include fewer or more openings with different configurations, depending on features included within the mobile device designated for use with the case 10.

The mobile device case 10, shown in FIGS. 1A, 1B, 2, and 3A-6 preferably includes two main pieces or subcomponents—an upper piece 18a and a lower piece 18b separated along a crosswise perimeter C of the case 10. FIG. 2 is an exploded perspective view of a mobile device and case assembly 200, while FIG. 6 is a perspective view of the fully assembled mobile device and case assembly 200 during use of the case 10. Each of the upper piece 18a and the lower piece 18b includes retention elements (now shown) that preferably provide snap fit engagement between the respective pieces 18a, 18b.

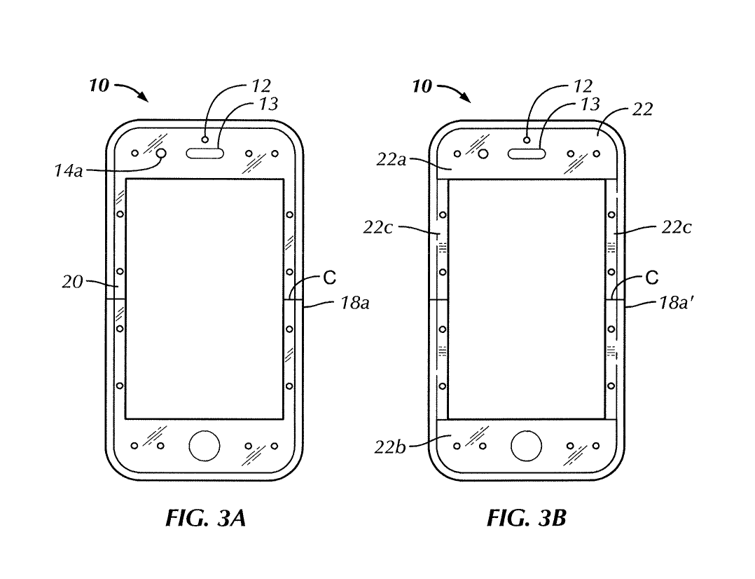

Referring particularly to FIGS. 1A, 3A, and 6 the upper piece 18a preferably includes a substantially contiguous mirror or mirror-like surface 20 positioned around the screen opening 16. The upper surface 20 thus includes a reflective material having properties that allow one or more users 500a, 500b (FIG. 6) of the device to show one or more reflective images 66a, 66b on the device case 10, as shown particularly in FIG. 6. Alternatively, as shown in FIG. 3B, an upper piece 18a′ can include sectioned off mirror or mirror-like surfaces, including an upper mirror or mirror-like surface 22a, a lower mirror or mirror-like surface 22b, and side mirrors or mirror-like surfaces 22c.

The upper piece 18a also includes a plurality of recessed lights 30 disposed at least partially within light openings 19. In the illustrated embodiment, the lights 30 are positioned on the surface 20. Additionally, or alternatively, the lights 30 may be positioned around the outer bezel of the case 10. The lights 30 allow the front of the case 10 to be illuminated, as shown in FIG. 6. Illumination created by the lights 30 provide one or more users 500a, 500b to enhance photographs taken with the mobile device 400. The lights 30 are preferably electrically coupled to one or more contacts 32 (see FIG. 1A) disposed within the interior of the upper piece 18a. The contacts 32 are in turn coupled to a small rechargeable battery (not shown) positioned within the case 10. The rechargeable battery may be recharged by solar power, a power cord (not shown) of the mobile device, or by a separate power source (now shown) for the case, e.g. a cord or a battery. When the battery is powered by the device power cord, the case 10 preferably includes an electronic interface (now shown) that allows elements of the cord to electronically couple with light elements included within the case. The lights 30 are also preferably electronically coupled to a blue-tooth enabled take-picture button 85, i.e. a shutter button, and a slidable light function button 80 (see FIG. 1B) positionable to an off position and high-medium-low positions for controlling the level of illumination for the plurality of lights 30.

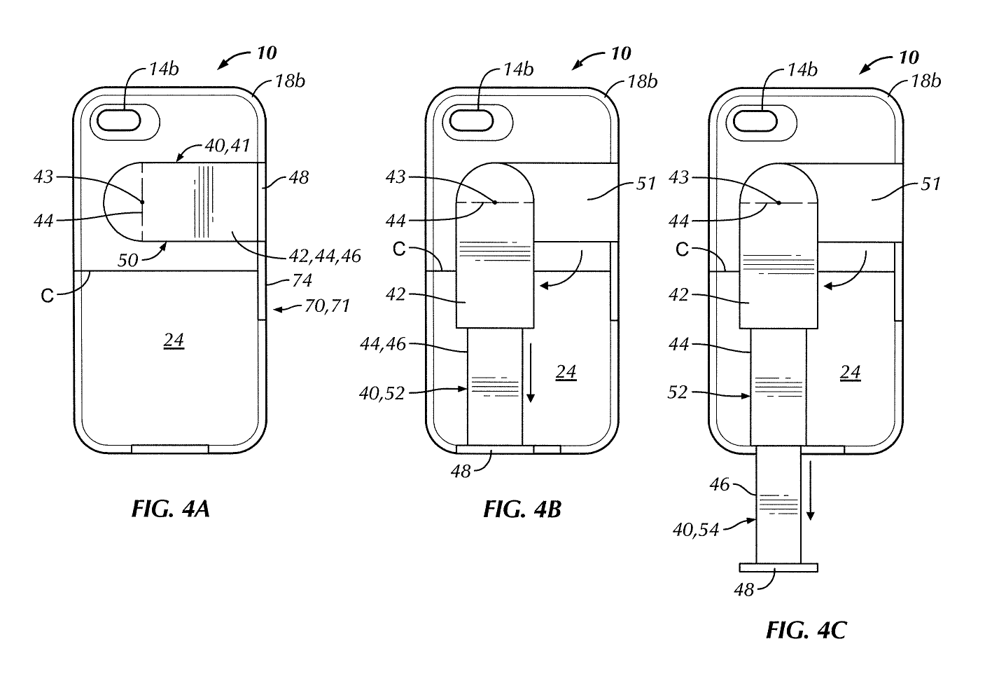

For positioning of the case 10 for reading or taking photographs, for example, the case includes a plurality of adjustable stand elements that provide vertical, horizontal, and angular positioning of the case with respect to the position of one or more users 500a, 500b. Stand elements for the case 10 include a kick-stand element 40, a portrait stand element 60 for portrait orientation 10a (FIGS. 1A and 6), and a landscape stand element 70 for landscape orientation 10b (FIG. 1B). Each of the stand elements are coupled to a rear surface 24 of the upper or lower case piece 18a or 18b. Referring to FIGS. 4A-4C, the kick-stand element 40 is shown in a first stowed position 50, with the kick-stand element 40 being substantially flat against the rear surface 24 of the upper case 18a and contained in a recess 51.

The kick-stand element 40 is tiltable to various positions with respect to tilt or hinge line 43. Exemplary tilted positions are shown in FIGS. 1A and 6. To facilitate positioning, the kick-stand element 40 includes a tilting, rotating segment 42 pivotable with respect to a rotation point 43, at least one telescoping segment extending therefrom, and a grippable end 48, e.g., a flange member.

In the illustrated embodiment, for example, the at least one telescoping segment includes a first telescoping element 44 extendable from segment 42 to a first extended position 52, and a second telescoping element 46 extendable from first telescoping element 44 to a second ended position 54.

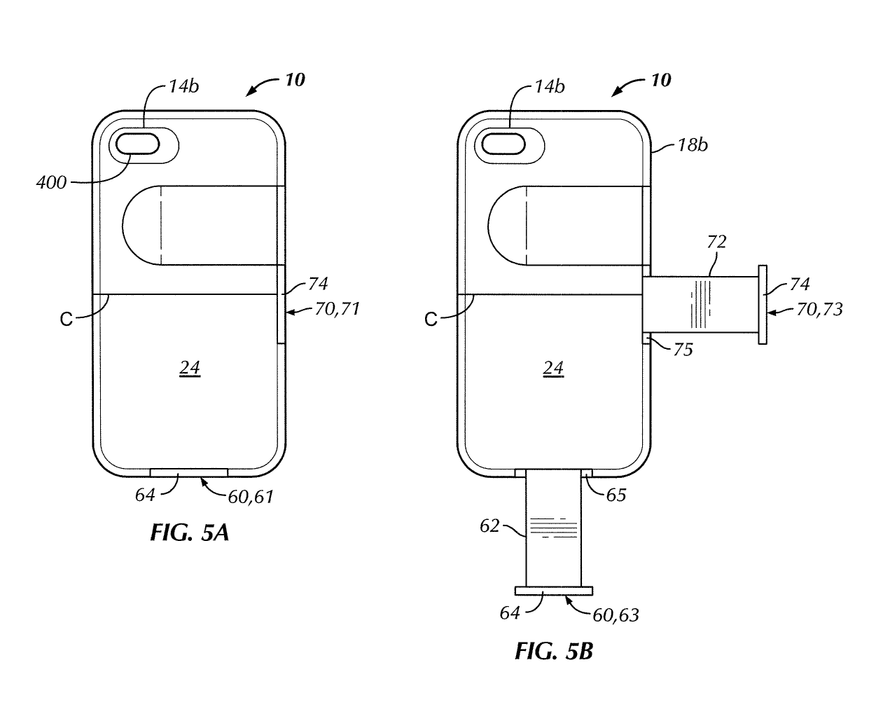

Referring particularly to FIGS. 1A, 1B, 5A, 5B, and 6, the case 10 includes a portrait stand element 60 for portrait orientation 10a and a landscape stand element 70 for landscape orientation 10b each of which functions with the kick-stand element 40 for support of the case 10 as shown in FIGS. 1A, 1B and 6. The portrait stand element 60 is shown in FIG. 5A in a stowed position 61, positioned within a recessed area 65. In FIG. 5B, the portrait stand element 60 is shown in an extended position 63, which shows a telescoping segment 62 and a grippable end 64 of the portrait stand element 60. Similarly, in FIG. 5A, the landscape stand element 70 is shown in a stowed position 71 positionable with a recessed area 75. In FIG. 5B, the landscape stand element 70 is shown in an extended position 73. When extended, the landscape stand element is shown including a telescoping segment 72 and a grippable end 74. In one embodiment, at least one of the portrait stand element 60 and the landscape stand element 70 may also be extendable into a selfie-stick arm.

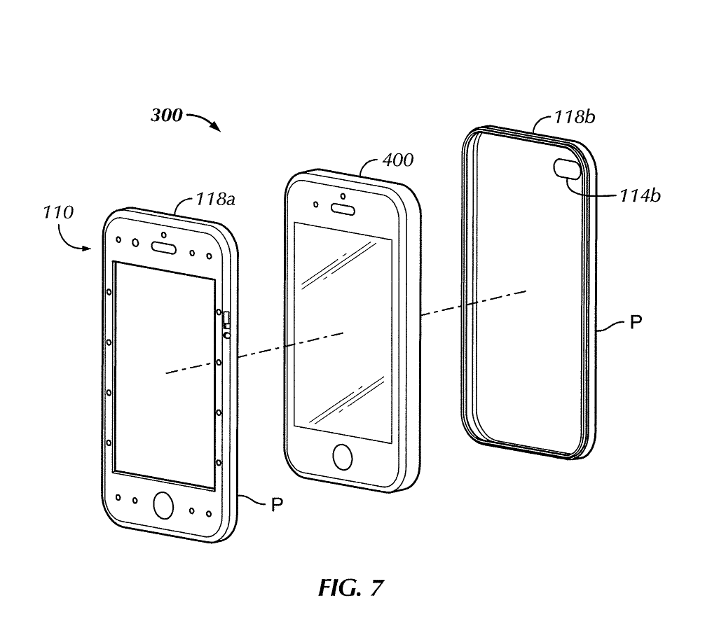

FIG. 7 is an exploded perspective view of a mobile device and case assembly 300, including an alternative case 110 and a mobile device 400. In this alternative embodiment, the case 100 includes among other features an upper or front piece 118a and a lower or rear piece 118b separated along a longitudinal perimeter P of the case 100. The reference numerals of the second preferred embodiment are distinguishable from those of the first preferred embodiment by a factor of one-hundred (100), but otherwise indicate the same elements as indicated in the first preferred embodiment, except as otherwise specified. The mobile device case 110 of the second preferred embodiment is substantially similar to that of the first preferred embodiment. The description of certain similarities between the embodiments are omitted herein for the sake of brevity and convenience, and, therefore, is not limiting.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

I claim:

1. A mobile device case, comprising:
a first piece having a front surface, at least a portion of the front surface being reflective, and the first piece including a plurality of openings;
a plurality of light sources disposed within the plurality of openings;
a second piece releasably engageable with the first piece, the first and second pieces being dimensioned to receive a mobile device therebetween; and
a plurality of adjustable stand elements, attached to at least one of the first and second pieces, for portrait and landscape positioning of the case.

2. The mobile device case of claim 1, wherein the plurality of stand elements comprises:
a kick-stand element, coupled to a rear surface of the first or second piece, the kick-stand element being tiltable and rotatable relative to the mobile device case for angular positioning of the mobile device case;
an adjustable portrait stand element coupled to a base end of the first or second piece, to cooperate with the kick-stand element for portrait orientation of the mobile device case; and
an adjustable landscape stand element coupled to the first or second piece and oriented perpendicularly to the adjustable portrait stand element, to cooperate with the kick-stand element for landscape orientation of the mobile device case.

3. The mobile device case of claim 2, wherein the kick-stand element comprises a tilting, rotating segment, pivotable and tiltable with respect to a rotation point, at least one telescoping segment extendable from the tilting, rotating segment, thereby permitting the kick-stand element to extend and collapse, and a grippable end segment extending from the at least one telescoping segment.

4. The mobile device case of claim 3, wherein the kick-stand end segment comprises a flange member.

5. The mobile device case of claim 2, wherein the adjustable portrait stand element comprises at least one telescoping segment and a grippable end segment extending therefrom, the portrait stand element being movable between a stowed position and an extended position.

6. The mobile device case of claim 5, wherein the adjustable portrait stand element is received within a recess in the first or second pieces in the stowed position.

7. The mobile device case of claim 5, wherein the portrait stand end segment comprises a flange member.

8. The mobile device case of claim 2, wherein the adjustable landscape stand element comprises at least one telescoping segment and a grippable end segment extending therefrom, the landscape stand element being movable between a stowed position and an extended position.

9. The mobile device case of claim 8, wherein the adjustable landscape stand element is received within a recess in the first or second pieces in the stowed position.

10. The mobile device case of claim 8, wherein the landscape stand end segment comprises a flange member.

11. The mobile device case of claim 1, wherein the plurality of light sources are recessed within the first piece.

12. The mobile device case of claim 1, wherein the reflective portion of the front surface is a mirror or mirror-like surface to provide a reflective image.

13. The mobile device case of claim 1, wherein the light sources are electrically coupled with a shutter button.

14. The mobile device case of claim 1, wherein the light sources are electrically coupled to an illumination level button to control and adjust a level of illumination of the light sources.

15. The mobile device case of claim 14, wherein the illumination level button is a slidable button.
